(19) United States
(12) Patent Application Publication
(10) Pub. No.: US 2008/0301344 A1
(43) Pub. Date: Dec. 4, 2008

(54) SYSTEM FOR EXPANDABLY CONNECTING ELECTRONIC DEVICES

(75) Inventor: MING-CHIH HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/942,725

(22) Filed: Nov. 20, 2007

(30) Foreign Application Priority Data
Jun. 1, 2007 (CN) 200710200748.6

(51) Int. Cl. G06F 13/18

(52) U.S. Cl. 710/110

(57) ABSTRACT

An exemplary system for expandably connecting electronic devices includes a master device, a first slave device, and a second slave device. The first and second slave device each has a control chip and an address setting module. The control chip includes a bus interface connected to the master device via a common bus. The address setting module has a counter unit. The master device sets a first address for the control chip and the counter unit of the first slave device, the counter unit of the first slave device calculates the first address and sends a calculated address to the control chip and the counter unit of the second slave device as a second address of the second slave device. The first address and the second address are different from each other, thus a plurality of slave devices can connected to the master device via a common bus.

### BACKGROUND OF THE INVENTION

1. Field of the Invention

The present invention relates to circuits for connecting electronic devices, and particularly to a system for expandably connecting electronic devices.

2. Description of Related Art

Referring to FIG. 1, a structure of a commonly used system for connecting electronic devices is shown, the system includes a master device 13 and a slave device 12, the slave device 12 includes a control chip 122 having an I2C interface 124, and an address setting module 126. The I2C interface 124 of the slave device 12 is connected to the master device 13 via an I2C bus 16. The I2C bus 16 is configured for assisting bidirectional data transfer between the master device 13 and the slave device 12. The address setting module 126 assigns a unique bus address to the control chip 122 of the slave device 12 to be identified by the master device 13.

If the master device is connected to several slave devices, because the address of the slave devices is fixed, each of the slave devices must be connected in parallel to the master device via a separate I2C bus. This adds to costs due to needing a plurality of I2C buses.

What is needed, therefore, is a system expandably connecting a plurality of electronic devices via a single I2C bus.

### SUMMARY OF THE INVENTION

An exemplary system for expandably connecting electronic devices includes a master device, a first slave device, and a second slave device. The first and second slave device each has a control chip and an address setting module. The control chip includes a bus interface connected to the master device via a common bus. The address setting module has a counter unit. The master device sets a first address for the control chip and the counter unit of the first slave device, the counter unit of the first slave device calculates the first address and sends a calculated address to the control chip and the counter unit of the second slave device as a second address of the second slave device.

Other advantages and novel features will become more apparent from the following detailed description when taken in conjunction with the accompanying drawing, in which:

### BRIEF DESCRIPTION OF THE DRAWINGS

FIG. 1 is a schematic diagram of a system for expandably connecting electronic devices in accordance with an embodiment of the present invention;

FIG. 2 is a circuit diagram of an address setting module of FIG. 1; and

FIG. 3 is a schematic diagram of a commonly used system for connecting electronic devices.

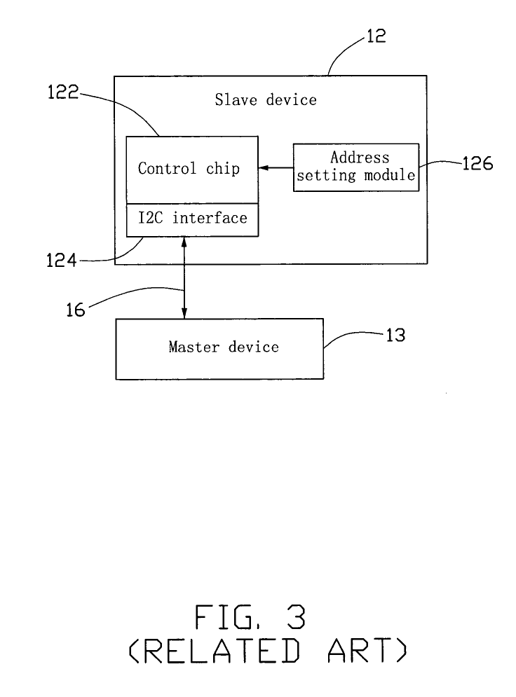

### DETAILED DESCRIPTION OF THE INVENTION

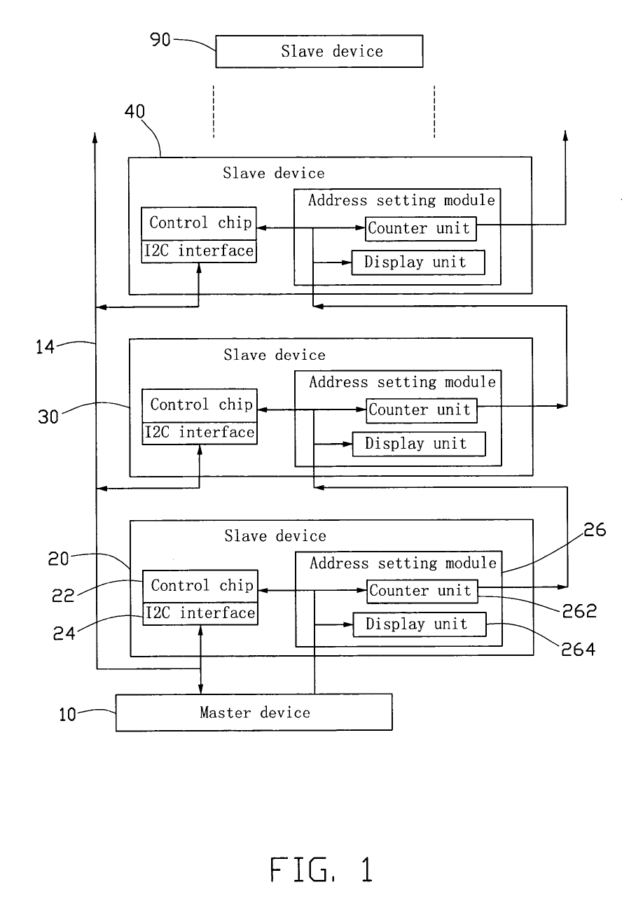

Referring to FIG. 1, a system in accordance with an embodiment of the present invention includes a master device 10, and a plurality of slave devices 20, 30, . . . , 90. Each of the slave devices 20, 30, . . . , 90 includes a control chip 22 and an address setting module 26. Each control chip 22 includes an I2C interface 24, which is connected to the master device 10 via a common I2C bus 14. Each slave device 20, 30, . . . , 90 has a similar structure, and the slave device 20 is used herein as an example.

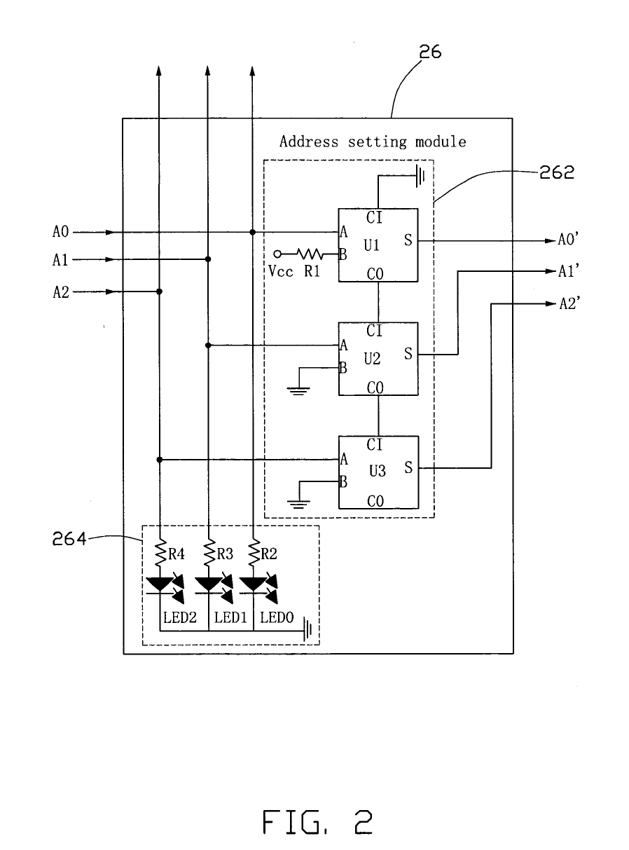

Referring to FIG. 2, the address setting module 26 of the slave device 20 includes a counter unit 262 and a display unit 264. The counter unit 262 includes three adders U1-U3 connected in series. The adder U1 has an A input terminal connected to the master device 10 to receive a first address bit A0, a B input terminal connected to a VCC source via a resistor R1 to receive a high voltage, a carry input terminal C1 connected to ground, and a carry output terminal C0 connected to a carry input terminal C1 of the adder U2. An A input terminal of the adder U2 is connected to the master device 10 to receive a second address bit A1, a B input terminal of the adder U2 is connected to ground, and a carry output terminal C0 of the adder U2 is connected to a carry input terminal C1 of the adder U3. An A input terminal of the adder U3 is connected to the master device 10 to receive a third address bit A2, a B input terminal of the adder U3 is grounded. The adders U1-U3 calculate the three address bits A2, A1, and A0, and transmits a count address A2′, A1′, and A0′ from a sum terminal S of each of the adders U1-U3 respectively. The display unit 264 includes three light emitting diodes LED0-LED2, the anodes of the light emitting diodes LED0-LED2 are connected to the A input terminals of the adders U1-U3 via resistors R2-R4, respectively, the cathodes of the light emitting diodes LED0-LED2 are all grounded. The address bits A2, A1, and A0 are also provided to the control chip 22 to set an address of the slave device 20.

Each of the slave devices 30, . . . , 90 has a structure similar to that of the slave device 20, but the A input terminals of the adders U1-U3 of each slave device 30, . . . , 90 are connected to the sum output terminals S of the adders U1-U3 of the former slave device, respectively. The address received at the control chip 22 and the A input terminals of the adders U1-U3 of the slave devices 30, . . . , 90 are obtained by adding 1 to the address of the former slave device.

At the beginning of assigning addresses to the slave devices 20, . . . , 90, the master device 10 transmits the address A2A1A0 to the slave device 20 as the first address, for example, the first address A2A1A0 is “000”, the logic 1 sate corresponds to the logic high input voltage, and the logic 0 sate corresponds to the logic low input voltage. The light emitting diodes LED0-LED2 emit no light due to receiving low voltages at the anodes to indicate the address received at the slave device 20 is “000”. The counter unit 262 adds 1 to the first address, and transmits the result A2′A′A0′ to the slave device 30, thus a second address obtained by the slave device 30 is “001” that is the first address plus 1. The light emitting diode LED0 in the slave device 30 emits light, the light emitting diodes LED1 and LED2 emit no light to indicate that the address received at the slave device 30 is “001”. The second address is also sent to the slave device 40 through the counter unit 262 in the slave device 30 in this manner. Thus the slave devices 20, . . . , 90 each obtains a unique address other than that of the other slave devices. In other embodiments, the number of the address bits may be other than three, according to practical requirements. Thus, different numbers of slave devices can be connected to the master device through a common bus to enable low-cost expandability of the system.

The foregoing description of the exemplary embodiment of the invention has been presented only for the purposes of illustration and description and is not intended to be exhaustive or to limit the invention to the precise forms disclosed. Many modifications and variations are possible in light of the above teaching. The embodiment was chosen and described in order to explain the principles of the invention and its practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A system for expandably connecting electronic devices, comprising:
a master device; and
a first slave device and a second slave device, each of the slave devices having a control chip and an address setting module, each control chip comprising a bus interface connected to the master device via a common bus, each address setting module having a counter unit, the master device setting a first address for the control chip and the counter unit of the first slave device, the counter unit of the first slave device calculating the first address and sending a calculated address to the control chip and the counter unit of the second slave device as a second address of the second slave device.

2. The system as claimed in claim 1, wherein the counter unit of the first slave device comprises:
a first adder comprising a first input terminal connected to the master device, a second input terminal connected to a power supply via a first resistor, a carry input terminal connected to ground, a carry output terminal, and a sum output terminal;
a second adder comprising a first input terminal connected to the master device, a second input terminal connected to ground, a carry input terminal connected to the carry output terminal of the first adder, a carry output terminal, and a sum output terminal; and
a third adder comprising a first input terminal connected to the master device, a second input terminal connected to ground, a carry input terminal connected to the carry output terminal of the second adder, a carry output terminal being null, and a sum output terminal, all the sum output terminals are all connected to the control chip and the counter unit of the second slave device.

3. The system as claimed in claim 2, wherein the counter unit of the second slave device comprises:
a fourth adder comprising a first input terminal connected to the sum output terminal of the first adder, a second input terminal connected to a power supply via a second resistor, a carry input terminal connected to ground, and a carry output terminal;
a fifth adder comprising a first input terminal connected to the sum output terminal of the second adder, a second input terminal connected to ground, a carry input terminal connected to the carry output terminal of the fourth adder, and a carry output terminal; and
a sixth adder comprising a first input terminal connected to the sum output terminal of the third adder, a second input terminal connected to ground, a carry input terminal connected to the carry output terminal of the fifth adder, a carry output terminal being null.

4. The system as claimed in claim 3, wherein the second slave device comprises three light emitting diodes, the anodes of the three light emitting diodes are connected to the first input terminals of the fourth, fifth, and sixth adders via a corresponding resistor, respectively, the cathodes of the light emitting diodes are grounded.

5. The system as claimed in claim 2, wherein the first slave device comprises three light emitting diodes, the anodes of the three light emitting diodes are connected to the first input terminals of the first, second, and third adders via a corresponding resistor, respectively, the cathodes of the light emitting diodes are grounded.

6. The system as claimed in claim 2, wherein each adder is a binary adder.

7. A system for expandably connecting electronic devices, comprising:
a master device; and
a first slave device comprising a control chip and an address setting module, the control chip comprising a bus interface connected to the master device via a bus, the address setting module having a counter unit, the master device setting a first address for the control chip and the counter unit of the first slave device, the counter unit of the first slave device calculating the first address and generating a calculated address different from the first address; and
a second slave device comprising a control chip, the control chip comprising a bus interface connected to the master device via the bus, the control chip receiving calculated address output from the first slave device as a second address of the second slave device.

8. The system as claimed in claim 7, wherein the counter unit of the first slave device comprises:
a first adder comprising a first input terminal connected to the master device, a second input terminal connected to a power supply via a first resistor, a carry input terminal connected to ground, a carry output terminal, and a sum output terminal;
a second adder comprising a first input terminal connected to the master device, a second input terminal connected to ground, a carry input terminal connected to the carry output terminal of the first adder, a carry output terminal, and a sum output terminal; and
a third adder comprising a first input terminal connected to the master device, a second input terminal connected to ground, a carry input terminal connected to the carry output terminal of the second adder, a carry output terminal being null, and a sum output terminal, all the sum output terminals are all connected to the control chip of the second slave device.

9. The system as claimed in claim 8, wherein the first slave device comprises three light emitting diodes, the anodes of the three light emitting diodes are connected to the first input terminals of the first, second, and third adders via a corresponding resistor, respectively, the cathodes of the light emitting diodes are grounded.

10. The system as claimed in claim 8, wherein each adder is a binary adder.
